(19) United States
(12) Patent Application Publication
(10) Pub. No.: US 2005/0162391 A1
(43) Pub. Date: Jul. 28, 2005

(54) Device for controlling light source of an optical mouse by pulse width modulation

(75) Inventor: Chia-Chun Lin, Nantou City (TW)

Correspondence Address: BACON & THOMAS, PLLC, 625 SLATERS LANE, FOURTH FLOOR, ALEXANDRIA, VA, 22314, US

(73) Assignee: Sunplus Technology CO., Ltd., Hsinchu (TW)

(21) Appl. No.: 10/967,174

(22) Filed: Oct. 19, 2004

(30) Foreign Application Priority Data
Jan. 28, 2004 (TW) 093101894

(51) Int. Cl. G09G 5/08

(52) U.S. Cl. 345/163

(57) ABSTRACT

A device for controlling light source of an optical mouse by pulse width modulation includes an image sensor, a light source, a pulse width modulation generator, and a light-source controller. The image sensor is used for capturing an image. The light source provides illumination required for the image sensor to capture an image. The pulse width modulation generator generates a pulse-width modulated waveform. The light-source controller uses the pulse-width modulated waveform to illuminate the light source on and off alternatively.

### BACKGROUND OF THE INVENTION

1. Field of the Invention

The present invention relates to the technical field of optical mouse, and more particularly to a device for controlling light source of an optical mouse by pulse width modulation (PWM).

2. Description of Related Art

In general, a typical optical mouse has a light-emitting diode (LED) for irradiating light to a mouse pad or an object. Then, an image sensor is used to capture an image frame of the mouse pad. The direction and amount of movement of the optical mouse are thus determined by displacement of the optical mouse in terms of motion vectors as a result of a comparison of images captured in different time. The LED of the typical optical mouse is illuminated primarily by controlling a shutter mode. FIG. 1 shows a control timing diagram illustrating the illumination control of a LED when the shuttle mode is off, wherein the frame signal is a starting signal or a synchronization signal for each image frame. The LED is turned on during the active period of the optical mouse, and turned off during the idle period of the optical mouse. Hence, the LED ON/OFF time extends over the whole frame. FIG. 2 illustrates a control timing diagram showing the illumination control of a LED when the shutter mode is on, wherein illumination of the LED is subject to the shutter during the active period of the optical mouse; namely, the LED is turned on only when the shutter is opened. Hence, it is apparent that the light source of the typical optical mouse is always on during the period of forming an image.

With the aforementioned optical mouse, when the image sensor has a high sensitivity and is very sensitive to light, it is likely to result in that the image sensed by the image sensor is still in a saturated state even through the shutter is sized to the most miniature extent because the LED remains on during the shutter-on period or even during the whole active period of the optical mouse, which may cause malfunction of the optical mouse. In addition, the continuous illumination of the LED will greatly increase instant current consumption. In an application requiring a specification such as a USB suspend mode in which a USB interface provides a current up to 500 μA at its maximum, it results in that the USB optical mouse cannot meet that specification, and thus, a motion wake-up function is difficult to be implemented.

Therefore, it is desirable to provide an improved a device for controlling light source of an optical mouse by pulse width modulation to mitigate and/or obviate the aforementioned problems.

### SUMMARY OF THE INVENTION

It is therefore an object of the present invention to provide a device for controlling light source of an optical mouse by pulse width modulation so as to decrease current consumption of the light source in an average manner.

It is another object of the present invention to provide a device for controlling light source of an optical mouse by pulse width modulation so as to illuminate the light source of the optical mouse in a flexible control manner and further prevent the light source from being too bright to cause an image being saturated by detection of an image sensor.

It is a further object of the present invention to provide a device for controlling light source of an optical mouse by pulse width modulation so that a USB optical mouse can execute a motion wake-up function in a suspend mode.

To attain the aforesaid objects, a device for controlling light source of an optical mouse by pulse width modulation according to the present invention includes an image sensor for capturing an image, a light source for providing illumination required for the image sensor to capture an image, a pulse width modulation generator for generating at least one pulse-width modulated waveform, and a light-source controller for illuminating the light source on and off alternatively by using the pulse-width modulated waveform during the period of forming an image.

In addition, the present invention provides a device for controlling light source of an optical mouse by pulse width modulation, which includes an image sensor for capturing an image, a shutter for enabling the image sensor to capture an image when the shutter is opened, a light source for providing illumination required for the image sensor to capture an image, a pulse width modulation generator for generating at least one pulse-width modulated waveform, and a light-source controller for illuminating the light source on and off alternatively by using the pulse-width modulated waveform when the shutter is opened.

Other objects, advantages, and novel features of the invention will become more apparent from the following detailed description when taken in conjunction with the accompanying drawings.

### BRIEF DESCRIPTION OF THE DRAWINGS

FIG. 1 is a timing diagram illustrating the illumination control of a LED of a typical optical mouse when the shutter mode is off;

FIG. 2 is a timing diagram illustrating the illumination control of a LED of a typical optical mouse when a shutter mode is on;

FIG. 3 is a functional block diagram showing a device for controlling light source of an optical mouse by pulse width modulation according to the present invention;

FIG. 4 shows a configuration of a pulse width modulation generator according to the present invention;

FIG. 5 is a timing diagram illustrating an operation of a device for controlling light source of an optical mouse by pulse width modulation according to the present invention;

FIG. 6 is another timing diagram illustrating an operation of a device for controlling light source of an optical mouse by pulse width modulation according to the present invention; and

FIGS. 7A and 7B shows changes in waveforms illustrating LED's current-consumption relationship between a prior art and the present invention.

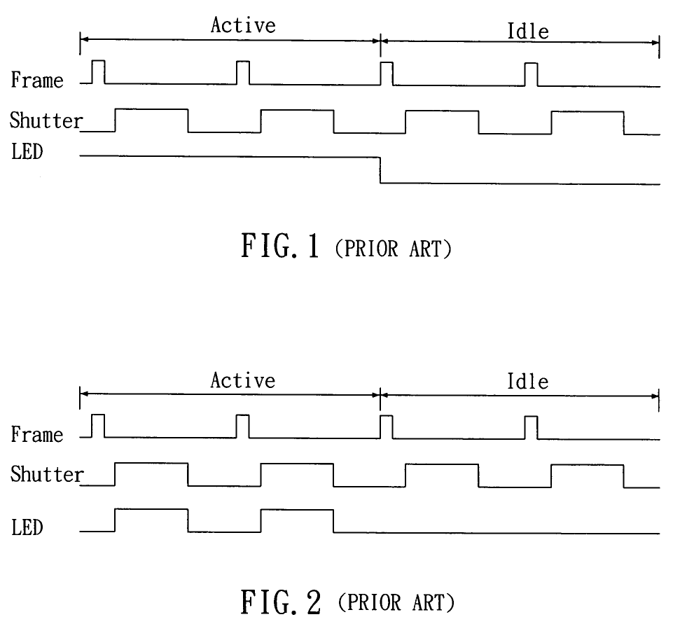

### DETAILED DESCRIPTION OF THE PREFERRED EMBODIMENT

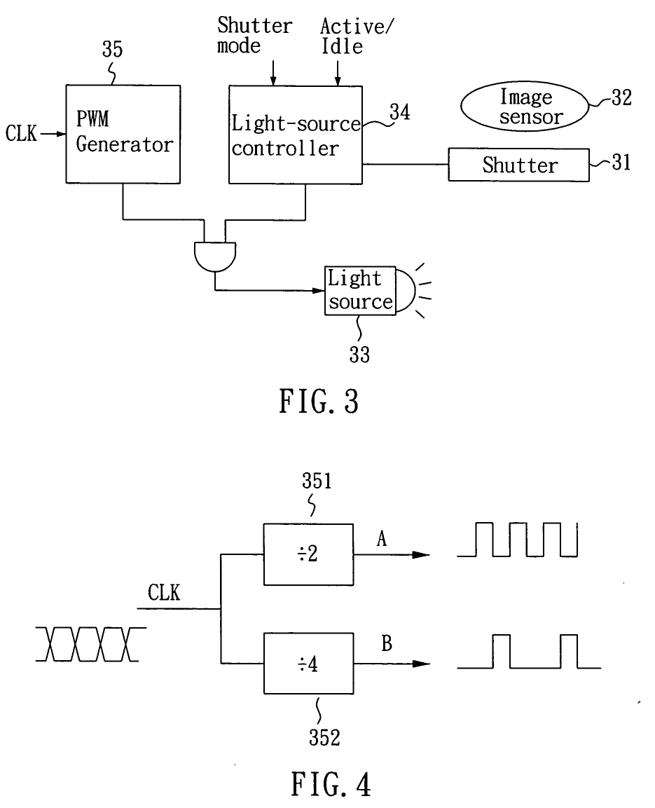

FIG. 3 is a functional block diagram illustrating a device for controlling light source of an optical mouse by pulse width modulation according to the present invention, which comprises a shutter 31, an image sensor 32, a light source 33, a light-source controller 34 and a pulse width modulation (PWM) generator 35. The light source 33 is preferably a light-emitting diode (LED). The light-source controller 34 generates a light-source control signal in accordance with the status of the optical mouse (Active/Idle) and the shutter mode. The light-source control signal combines with the PWM waveform generated by the PWM generator 35 to control illumination of the light source 33.

FIG. 4 shows a configuration of the PWM generator 35, which employs at least one frequency divider 351, 352 to divide frequency of a clock signal (CLK) so that a desired PWM waveform is generated. In this embodiment, the PWM generator 35 has a ½ and a ¼ frequency dividers 351, 352 for respectively dividing the CLK frequency (f), resulting in a PWM waveform ‘A’ having a frequency of f/2 and a PWM waveform ‘B’ having a frequency of f/4. In practice, one of the two PWM waveforms ‘A’ and ‘B’ is selected for output; for example, the PWM waveform ‘A’ having a higher frequency is selected for output when the environment is less illuminated or the image sensor 32 is less sensitive to the light.

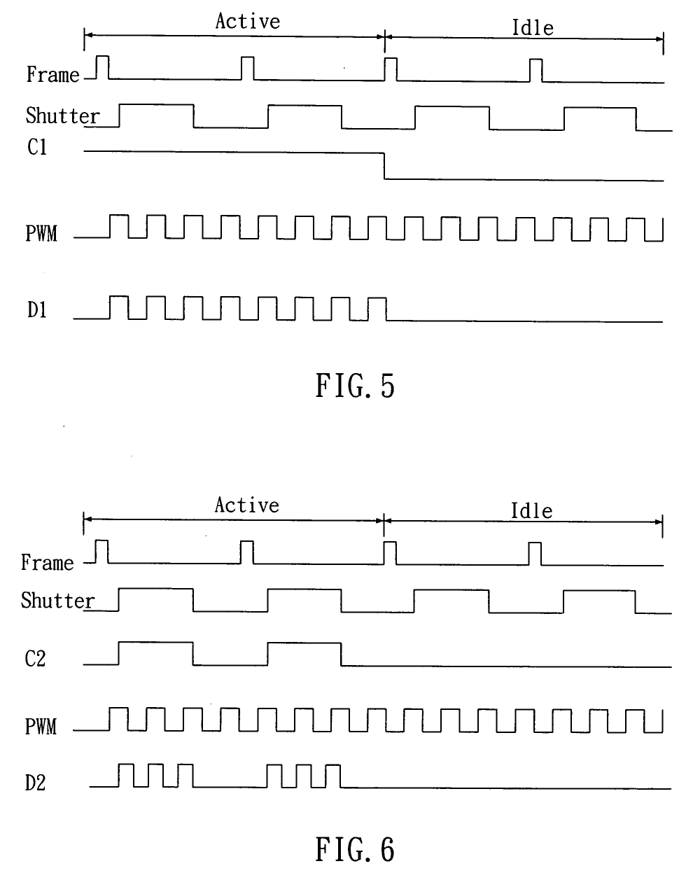

FIG. 5 is a timing diagram illustrating the operation of the device for controlling light source of an optical mouse by pulse width modulation according to the present invention. Also with reference to FIG. 3, the shutter 31 is periodically opened when the optical mouse is activated so that the image sensor 32 can capture the image of a mouse pad. If the shutter mode is off, a light-source control signal C1 generated by the light-source controller 34 is set to a high voltage level during the active period of the optical mouse and to a low voltage level during the idle period of the optical mouse. The light-source control signal C1 combines with the PWM waveform outputting from the PWM generator 35 to form a PWM light-source switch signal D1 for illumination of the light source 33.

FIG. 6 is another timing diagram illustrating the operation of the device for controlling light source of an optical mouse by pulse width modulation according to the present invention. If the shutter mode is on, a light-source control signal C2 generated by the light-source controller 34 is set to a high voltage level during the period that the shutter is opened and to a low voltage level during the period that the shutter is closed. The light-source control signal C2 combines with the PWM waveform outputting from the PWM generator 35 to form a PWM light-source switch signal D2 for illumination of the light source 33.

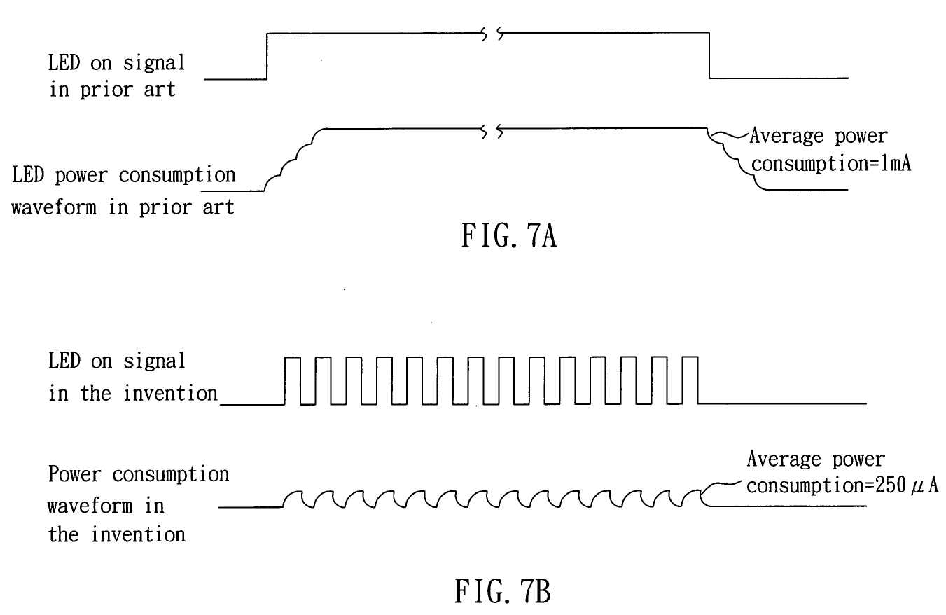

From the aforesaid timing diagrams, it is known that, in the present invention, the PWM waveform is used to illuminate the light-emitting diode. Hence, the LED is turned on and off alternatively regardless of whether the shutter mode is on or off, instead of continuous illumination during the shutter-open period or the whole active period of the optical mouse. Hence, the light source will not be too bright, so as to prevent the image sensor from being saturated. In addition, unlike the typical LED that greatly increases current consumption for an instant as a result of the continuous illumination during the period of forming an image (as shown in FIG. 7B illustrating an average current consumption of 1 mA as associated with the known optical mouse having the LED continuously illuminated), the LED is turned on and off alternatively according to the present invention. Hence, current consumption caused by the present invention is decreased. As shown in FIG. 7B, the average current consumption caused by the LED is less than 250 μA. Thus, the present invention can meet the specification for the USB suspend mode, so that a USB optical mouse is capable of performing the wake-up function in the suspend mode. Moreover, the PWM generator of the present invention is capable of generating PWM waveforms having different frequencies to be individually selected for output as desired. For example, a PWM waveform having a higher frequency is selected for output when the environment is less illuminated or the image sensor 32 is less sensitive to the light so that the brightness of the LED is enhanced and the illumination of the light source is easily controlled.

Although the present invention has been explained in relation to its preferred embodiments, it is to be understood that many other possible modifications and variations can be made without departing from the spirit and scope of the invention as hereinafter claimed.

1. A device for controlling light source of an optical mouse by pulse width modulation, comprising:
an image sensor for capturing an image;
a light source for providing illumination required for the image sensor to capture an image;
a pulse width modulation generator for generating at least one pulse-width modulated waveform; and
a light-source controller for illuminating the light source on and off alternatively by using the pulse-width modulated waveform.

2. The device for controlling light source of an optical mouse by pulse width modulation of claim 1, wherein the light-source controller uses the pulse-width modulated waveform to illuminate the light source on and off alternatively during an active period of the optical mouse.

3. The device for controlling light source of an optical mouse by pulse width modulation of claim 2, wherein the pulse width modulation generator includes at least one frequency divider for dividing the frequency of a clock signal so as to generate the at least one pulse-width modulated waveform.

4. The device for controlling light source of an optical mouse by pulse width modulation of claim 3, wherein the light source is a light-emitting diode.

5. A device for controlling light source of an optical mouse by pulse width modulation, comprising:
an image sensor for capturing an image;
a shutter for enabling the image sensor to capture an image when the shutter is opened;
a light source for providing illumination required for the image sensor to capture an image;
a pulse width modulation generator for generating at least one pulse-width modulated waveform; and
a light-source controller for illuminating the light source on and off alternatively by using the pulse-width modulated waveform when the shutter is opened.

6. The device for controlling light source of an optical mouse by pulse width modulation of claim 5, wherein the shutter is periodically opened.

7. The device for controlling light source of an optical mouse by pulse width modulation of claim 5, wherein the light-source controller uses the pulse-width modulated waveform to illuminate the light source on and off alternatively during an active period of the optical mouse.

8. The device for controlling light source of an optical mouse by pulse width modulation of claim 7, wherein the pulse width modulation generator includes at least one frequency divider for dividing the frequency of a clock signal so as to generate the at least one pulse-width modulated waveform.

9. The device for controlling light source of an optical mouse by pulse width modulation of claim 8, wherein the light source is a light-emitting diode.
